(19) United States
(12) Patent Application Publication
(10) Pub. No.: US 2025/0055157 A1
(43) Pub. Date: Feb. 13, 2025

(54) SECONDARY BATTERY AND MANUFACTURING METHOD THEREOF

(71) Applicant: SAMSUNG SDI CO., LTD., Yongin-si (KR)

(72) Inventors: Chanhyung LEE, Yongin-si (KR); Dong Myung LEE, Yongin-si (KR); Duckhyun KIM, Yongin-si (KR); Woonsuk JANG, Yongin-si (KR)

(21) Appl. No.: 18/423,758

(22) Filed: Jan. 26, 2024

(30) Foreign Application Priority Data
Aug. 10, 2023 (KR) 10-2023-0105064

(51) Int. Cl. H01M 50/54; H01M 10/04; H01M 50/103; H01M 50/15; H01M 50/474; H01M 50/533

(52) U.S. Cl. CPC H01M 50/54; H01M 10/049; H01M 50/103; H01M 50/15; H01M 50/474; H01M 50/533

(57) ABSTRACT

A secondary battery includes a can having a hexagonal bottom portion and a side portion with six surfaces, a hexagonal pillar-shaped electrode assembly accommodated inside the can, a first current collector plate coupled to a first side of the electrode assembly and facing the bottom portion, an insulating portion surrounding an outer surface of the first current collector plate and a portion of a side surface of the electrode assembly, the insulating portion insulating the first current collector plate from the can, and the insulating portion including a first insulating portion covering the outer surface of the first current collector plate, and a plurality of second insulating portions separated by a plurality of cutouts, the plurality of second insulating portions surrounding the portion of the side surface of the electrode assembly, and a cap plate coupled to an end portion of the side portion and sealing the can.

### CROSS-REFERENCE TO RELATED APPLICATION

This application claims priority to and the benefit of Korean Patent Application No. 10-2023-0105064, filed in the Korean Intellectual Property Office on Aug. 10, 2023, the entire contents of which is incorporated herein by reference.

### BACKGROUND

### 1. Field

The present disclosure relates to a secondary battery. More particularly, the present disclosure relates to a hexagonal pillar-shaped secondary battery.

### 2. Description of the Related Art

Secondary batteries are not only used as a power source for small electronic devices, e.g., mobile phones and laptop computers, but have also recently been used as a power source for driving motors in transportation vehicles, e.g., electric vehicles and hybrid vehicles. In the latter case, a battery module, in which a plurality of secondary batteries are combined, is used, and a typical battery module is composed of a plurality of cylindrical secondary batteries.

### SUMMARY

A secondary battery includes a can having a hexagonal bottom portion and a side portion having six surfaces, a hexagonal pillar-shaped electrode assembly accommodated inside the can, a first current collector plate coupled to a first side of the electrode assembly facing the bottom portion, an insulating portion configured to surround an outer surface of the first current collector plate and a portion of a side surface of the electrode assembly, and to insulate the first current collector plate and the can, and a cap plate coupled to an end portion of the side portion and sealing the can. The insulating portion includes a first insulating portion covering the outer surface of the first current collector plate, and a plurality of second insulating portions separated by a plurality of cutouts and configured to surround a portion of the side surface of the electrode assembly.

The electrode assembly may include a plurality of electrodes having different widths and stacked along a width direction of the secondary battery, and each of the plurality of electrodes may be formed in a quadrangular sheet shape. A long side of each of the plurality of electrodes may be parallel to a length direction of the secondary battery, and a short side of each of the plurality of electrodes may be located parallel to two surfaces facing each other among six surfaces forming the side portion.

The electrode assembly may include a plurality of first tabs located on the first side facing the bottom portion, and the plurality of first tabs may be bent along one direction, and coupled to the first current collector plate.

The plurality of cutouts may include a plurality of incision lines, and each of the plurality of second insulating portions may include an overlapping portion with a neighboring second insulating portion. The plurality of cutouts may include a plurality of incision grooves, and each of the plurality of second insulating portions may be in contact with a neighboring second insulating portion by side surfaces.

Each of the first insulating portion and the plurality of second insulating portions may include an insulating layer, and an adhesive layer located on an inner surface of the insulating layer, and the insulating portion may be attached to the outer surface of the first current collector plate and a portion of the side surface of the electrode assembly.

A manufacturing method of a secondary battery includes (i) fixing a first current collector plate to a first side of a hexagonal pillar-shaped electrode assembly, (ii) disposing a hexagonal insulating film having a plurality of cutouts on the outside of the first current collector plate, (iii) entering the insulating film and the electrode assembly into an opening of a can and moving into the can, and forming an insulating portion by bending of the insulating film due to contact with the can when entering the opening of the can, and (iv) sealing the can by coupling a cap plate to an end portion of the can. The insulating portion includes a first insulating portion covering an outer surface of the first current collector plate, and a plurality of second insulating portions covering a portion of a side surface of the electrode assembly.

The insulating film may include a hexagonal central portion facing the outer surface of the first current collector plate, and a peripheral portion surrounding the central portion, and the plurality of cutouts may be located in the peripheral portion, and separate the peripheral portion into a plurality of portions.

The plurality of cutouts may include a plurality of incision lines extended from six edges of the peripheral portion toward a center point of the central portion. The insulating film may contact the end portion of the can, and the plurality of second insulating portions may be formed as a plurality of peripheral portions are vertically bent from the central portion by movement of the electrode assembly, each of the plurality of second insulating portions has an overlapping portion with a neighboring second insulating portion.

The plurality of cutouts may include a plurality of V-shaped incision grooves in contact with six edges of the central portion. The insulating film may contact the end portion of the can, and the plurality of second insulating portions may be formed as a plurality of peripheral portions are vertically bent from the central portion by movement of the electrode assembly, each of the plurality of second insulating portions may be in contact with a neighboring second insulating portion by side surfaces.

A manufacturing method of a secondary battery includes (i) fixing a first current collector plate to a first side of a hexagonal pillar-shaped electrode assembly, (ii) attaching an insulating portion formed in a dual layer structure of an adhesive layer and an insulating layer to an outer surface of the first current collector plate and a portion of a side surface of the electrode assembly, (iii) accommodating the electrode assembly attached with the insulating portion inside a can, and (iv) sealing the can by coupling a cap plate to an end portion of the can.

The process of attaching the insulating portion may include, (i) preparing an insulating film including a hexagonal central portion facing the outer surface of the first current collector plate and a peripheral portion surrounding the central portion, and separating the peripheral portion into a plurality of portions by a plurality of cutouts, and (ii) attaching the central portion to the outer surface of the first current collector plate, and attaching the plurality of peripheral portions to a portion of the side surface of the electrode assembly by vertically bending the plurality of peripheral portions from the central portion. The plurality of cutouts may include one of a plurality of incision lines extended from six edges of the peripheral portion toward a center point of the central portion, and a plurality of V-shaped incision grooves in contact with six edges of the central portion.

### BRIEF DESCRIPTION OF THE DRAWINGS

Features will become apparent to those of skill in the art by describing in detail exemplary embodiments with reference to the attached drawings, in which:

FIG. 1 is a perspective view of a secondary battery according to a first embodiment.

FIG. 2 is a cross-sectional view taken along line A-A of FIG. 1.

FIG. 3 is a cross-sectional view taken along line B-B of FIG. 1.

FIG. 4 is an exploded perspective view of an electrode assembly and first and second current collector plates of the secondary battery shown in FIG. 2.

FIG. 5 is a partial enlarged view of an electrode assembly of the secondary battery shown in FIG. 3.

FIG. 6 is a perspective view of an electrode assembly and an insulating portion of the secondary battery shown in FIG. 2.

FIG. 7 is a perspective view of the insulating portion shown in FIG. 6.

FIG. 8 is a perspective view of an electrode assembly and an insulating portion of a secondary battery according to a second embodiment.

FIG. 9 is a perspective view of the insulating portion shown in FIG. 8.

FIG. 10 is a cross-sectional view of an electrode assembly and an insulating portion of a secondary battery according to a third embodiment.

FIG. 11 is a process flowchart of a manufacturing method of a secondary battery according to a fourth embodiment.

FIG. 12 is a perspective view of an electrode assembly and an insulating film during disposing of the insulating film of FIG. 11.

FIG. 13 and FIG. 14 are perspective views of an electrode assembly, an insulating portion, and a can during accommodating the electrode assembly of FIG. 11.

FIG. 15 is a perspective view of an electrode assembly and an insulating film during disposing of the insulating film of FIG. 11 according to another embodiment.

FIG. 16 is a perspective view of an electrode assembly, an insulating portion, and a can during accommodating the electrode assembly of FIG. 11 according to another embodiment.

FIG. 17 is a process flowchart of a manufacturing method of a secondary battery according to a fifth embodiment.

FIG. 18 is a perspective view of an electrode assembly and an insulating film during attaching the insulating portion of FIG. 17.

FIG. 19 is a perspective view of an electrode assembly, an insulating portion, and a can during accommodating the electrode assembly of FIG. 17.

FIG. 20 is a schematic diagram of a battery module according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

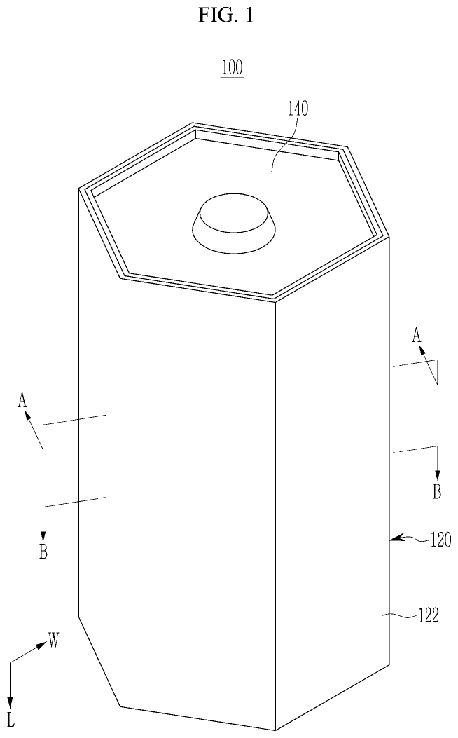

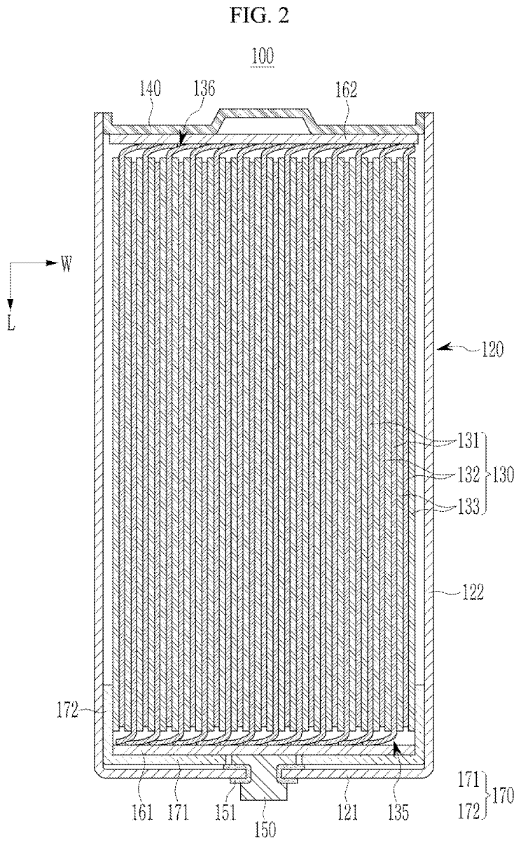

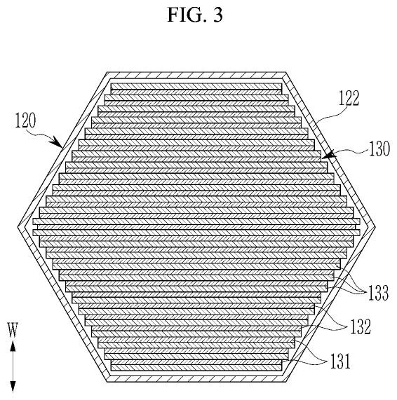

FIG. 1 is a perspective view of a secondary battery according to a first embodiment. FIG. 2 is a side cross-sectional view taken along line A-A of FIG. 1, and FIG. 3 is a top cross-sectional view taken along line B-B of FIG. 1.

Referring to FIG. 1 to FIG. 3, a secondary battery 100 of the present embodiment may include a can 120, an electrode assembly 130 accommodated in an interior of the can 120, and a cap plate 140 coupled to an opening of the can 120 and sealing the can 120. The can 120 and the cap plate 140 form (e.g., define or combine into) a hexagonal pillar shape with opposite sides (e.g., both sides) that are closed, and the electrode assembly 130 is formed in a stacked structure in which a plurality of sheet-shaped electrodes 131 and 132 are stacked along one direction.

The can 120 may include a bottom portion 121, and a side portion 122 connected to an edge of the bottom portion 121. The bottom portion 121 may be referred to as a top portion or upper surface portion when the can 120 is turned upside down. The bottom portion 121 may be a hexagonal metal plate (e.g., may have a hexagonal shape in a top view), and the side portion 122 may be a hexagonal pillar-shaped metal tube having a hollow inside (e.g., may include six sidewalls extending from respective edges of the hexagonal bottom portion 121 to be connected to each other into the hexagonal pillar surrounding an empty space). The bottom portion 121 and the side portion 122 may be integrally connected, and the side portion 122 may be perpendicular to the bottom portion 121. The bottom portion 121 may be a regular hexagon with all six sides having a same length.

For example, as illustrated in FIG. 2, an opening for installing a rivet 150 may be located at a center of the bottom portion 121. In another example, the secondary battery 100 may be provided with a terminal of a different type than the rivet 150, and in this case, the opening in the bottom portion 121 may be omitted. The can 120 may include a metal, e.g., may be made of steel, stainless steel, aluminum, or aluminum alloy.

Hereinafter, a direction parallel to a central axis of the can 120 is referred to as a ‘length direction L’ of the secondary battery (e.g., a longitudinal direction of the can 120 extending along the length direction L), and a direction along which two surfaces of the side portion 122 faces each other, among directions orthogonal to the length direction L, is referred to as a ‘width direction W’ of the secondary battery. While six surfaces (e.g., sidewalls) forming the side portion 122 include (e.g., consist of) three pairs of surfaces facing each other, a direction in which a pair of the surfaces face each other is referred to as the width direction W, for convenience. In FIG. 2, the length direction L coincides with the vertical direction, and the width direction W coincides with the horizontal direction (e.g., the width direction W may extend in any direction in a plane perpendicular to the length direction L).

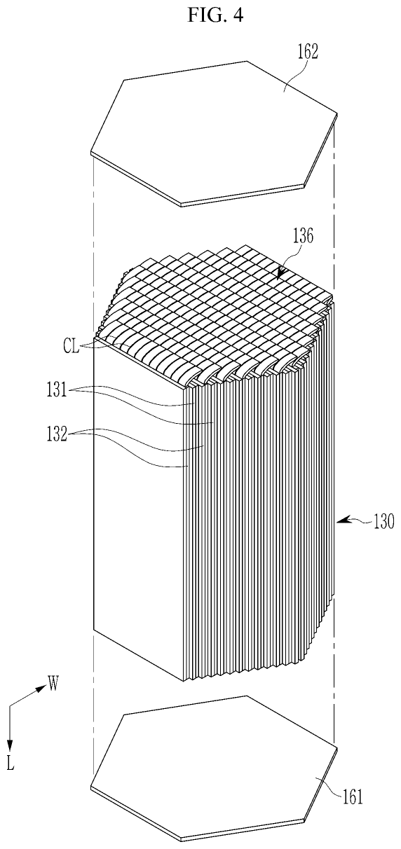

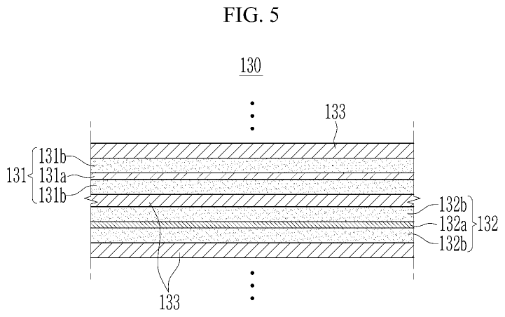

FIG. 4 is an exploded perspective view of the electrode assembly 130 and first and second current collector plates 161 and 162 of the secondary battery 100 shown in FIG. 2. FIG. 5 is a partial enlarged view of the electrode assembly 130 shown in FIG. 3.

Referring to FIG. 3 to FIG. 5, the electrode assembly 130 may include the plurality of sheet-shaped electrodes 131 and 132 that are sequentially stacked along the width direction W. Each of the plurality of electrodes 131 and 132 may be formed in a quadrangular sheet shape. A long side of each of the electrodes 131 and 132 may be parallel to the length direction L, and a short side of each of the electrodes 131 and 132 may be parallel to any two surfaces facing each other among six surfaces forming the side portion 122.

For example, the electrode assembly 130 may include a plurality of first electrodes 131 and a plurality of second electrodes 132 alternately disposed along the width direction W, and a plurality of separation layers 133 each located between a first electrode 131 and a second electrode 132 neighboring each other. Each of the plurality of separation layers 133 may be formed in a quadrangular sheet shape. The electrode assembly 130 is accommodated inside the can 120 together with an electrolyte.

The first electrode 131 may include a first substrate 131a, and a first active material layer 131b located on the first substrate 131a. The second electrode 132 may include a second substrate 132a, and a second active material layer 132b located on the second substrate 132a. The separation layer 133 insulates the first electrode 131 and the second electrode 132 while allowing movement of lithium ions.

For example, the first substrate 131a may include aluminum (Al) foil, and the first active material layer 131b may include a transition metal oxide, e.g., LiCoO₂, LiNiO₂, LiMn₂O₄, or the like. For example, the second substrate 132a may include copper (Cu) foil, nickel (Ni) foil, or the like, and the second active material layer 132b may include a carbon-based material, e.g., graphite. The separation layer 133 may include a polymer material, e.g., polyethylene or polypropylene.

For example, referring to FIG. 3, the electrode assembly 130 may include a plurality of electrodes 131 and 132 having different widths, such that a hexagon may be formed in a plan view (i.e., when viewed from the top). For example, referring to FIG. 3, an outline of the plurality of electrodes 131 and 132 in a plan view may have a shape of a hexagon and may correspond to (e.g., may substantially equal or fit within) an interior shape (e.g., outline) of the hexagonal-shaped can 120. Hereinafter, the term ‘in a plan view’ means ‘when viewed from the top.

Referring to FIG. 3, among the plurality of electrodes 131 and 132 forming the electrode assembly 130, two electrodes located outermost may have a smallest width, and the electrode located at a center of the electrode assembly 130 may have a largest width. For example, as illustrated in FIG. 3, the two outermost electrodes that have the smallest width in the electrode assembly 130 may be parallel to each other and at opposite edges of the electrode assembly 130, and the electrode that has the largest width in the electrode assembly 130 may be between and parallel to the two outermost electrodes. Widths of the electrodes 131 and 132 may gradually increase from an outer boundary of the electrode assembly 130 toward the center, e.g., from the two outermost electrodes toward the electrode in the center of the electrode assembly 130. The plurality of electrodes 131 and 132 may have the same height along the length direction L (FIG. 2).

When an electrode assembly wound in a cylindrical shape is positioned inside a hexagonal pillar-shaped can, an empty space may exist (e.g., remain) between the cylindrically-shaped electrode assembly and an edge of the hexagonal pillar-shaped can, thereby reducing battery capacity. In contrast, in the secondary battery 100 of the present embodiment, the electrode assembly 130 may include a plurality of sheet-shaped electrodes 131 and 132 that are stacked along one direction and fit (e.g., extend) within an entire interior of the hexagonal pillar-shaped can 120 with minimal empty space within the interior of the hexagonal pillar-shaped can 120, thereby increasing the output and capacity of the battery.

Referring to FIG. 2 and FIG. 4, the first electrode 131 may include a first tab 135 located on one side (e.g., lower side) along the length direction L, and the second electrode 132 may include a second tab 136 located on an opposite side (e.g., upper side) of the first tab 135. The first tab 135 may be a portion of the first substrate 131a extending downwardly, and the second tab 136 may be a portion of the second substrate 132a extending upwardly.

A plurality of incision lines CL may be located on each of the first tab 135 and the second tab 136, and each of the first tab 135 and the second tab 136 may be divided into a plurality of portions by the plurality of incision lines CL. Each of the first tab 135 and the second tab 136 may be bent in one direction, and may have an overlapping portion with a neighboring tab.

In order to bend the first tab 135, a jig may be in close contact with one of the outermost first tabs 135, and the jig may move along the width direction W to sequentially press and bent a plurality of the first tabs 135. The bending process of the second tab 136 may be performed in the same manner as the bending process of the first tab 135. The plurality of incision lines CL facilitates bending of the plurality of first tabs 135 and second tabs 136 during the bending process.

Referring to FIG. 2, each of the plurality of first tabs 135 and the plurality of second tabs 136 may overlap and press each other by bending to form a substantially flat surface. The first current collector plate 161 and the second current collector plate 162 each may be integrally fixed to each of the plurality of first tabs 135 and the plurality of second tabs 136, respectively, e.g., by laser welding. For example, the first current collector plate 161 and the second current collector plate 162 may be formed as a hexagonal metal plate, as viewed in a top view (e.g., each of the first and second current collector plates 161 and 162 may have a hexagonal shape having a shape and a size equal to that of bottom and top, respectively, of the electrode assembly 130 and completely covering the bottom and top, respectively, of the electrode assembly 130.

During the charging and discharging process of the secondary battery 100, the currents of the plurality of first electrodes 131 are collected in the first current collector plate 161, and the currents of the plurality of second electrodes 132 are collected in the second current collector plate 162. In a structure in which each of the plurality of first tabs 135 and the plurality of second tabs 136 are bent, the current collecting efficiency of the electrodes 131 and 132 may be increased, and the welding quality with the current collector plates 161 and 162 may be improved. In addition, since the height of the portion that is not related to the active material layers 131b and 132b, in the total height of the electrode assembly 130, may be minimized, the capacity of the secondary battery 100 may be increased.

The rivet 150 may be installed in an opening of the bottom portion 121 in a state surrounded by an insulation gasket 151, and may be coupled to the first current collector plate 161 to be charged to have the same polarity as the first electrode 131. That is, the rivet 150 may function as a first terminal (positive electrode terminal).

The cap plate 140 may cover the second current collector plate 162 and be coupled to an end portion of the side portion 122, so as to seal the can 120. For example, as illustrated in FIG. 2, the cap plate 140 may be electrically connected to the second current collector plate 162 to function as a second terminal (negative electrode terminal), and the cap plate 140 and the can 120 may contact (e.g., directly contact) each other, such that the can 120 may also be charged to have the same polarity as the second electrode 132.

In another example, the second current collector plate 162 may contact the can 120, and the cap plate 140 may maintain a state insulated from the second current collector plate 162 and the can 120 by an insulation member, and may be coupled to the end portion of the side portion 122. In this case, the can 120 may function as the second terminal, and the cap plate 140 may be electrically non-polar.

The cap plate 140 may be made of a flat metal plate, or may include a portion that is convexly deformed upwardly or downwardly. In addition, a notch groove may be located on at least one surface among inner and outer surfaces of the cap plate 140. The notch groove may be formed as a V-shaped or U-shaped groove, and may prevent explosion of the secondary battery 100 by breaking and releasing the internal gas when the internal pressure of the secondary battery 100 increases.

In yet another example, a plurality of first tabs may be located above the electrode assembly 130 to be electrically connected to the second current collector plate 162 and the can 120, and a plurality of second tabs may be located below the electrode assembly 130 to be electrically connected to the first current collector plate 161 and the rivet 150. In this case, the can 120 may be charged to have the same polarity as the first electrode 131, and the rivet 150 may be charged to have the same polarity as the second electrode 132.

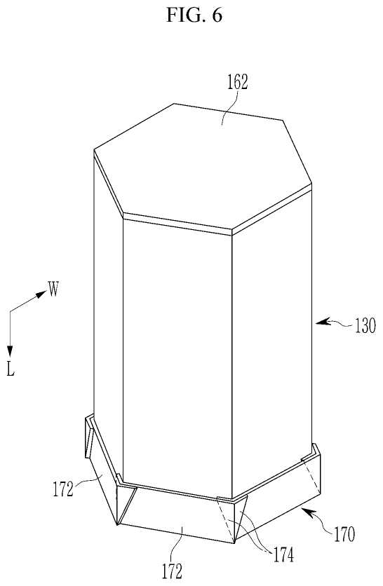

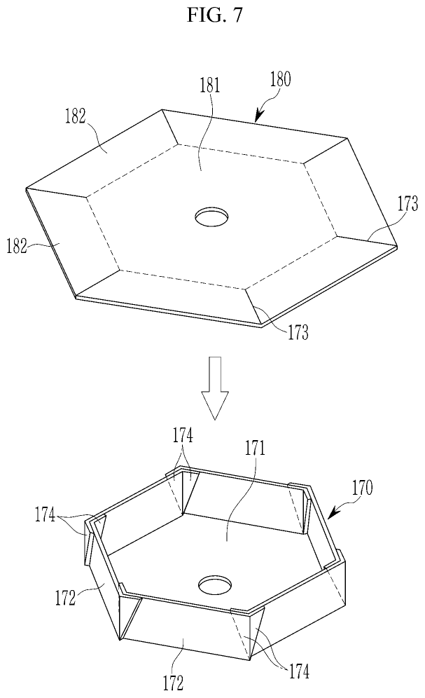

FIG. 6 is a perspective view of the electrode assembly 130 and an insulating portion of the secondary battery shown in FIG. 2. FIG. 7 is a perspective view of the insulating portion shown in FIG. 6.

Referring to FIG. 2, FIG. 6, and FIG. 7, the first current collector plate 161 and a portion of a side surface of the electrode assembly 130 may be surrounded by an insulating portion 170. As described above, since the first current collector plate 161 and the rivet 150 are charged to have the same polarity, and the can 120 is charged to have an opposite polarity from the first current collector plate 161 and the rivet 150, the first current collector plate 161 must maintain a state insulated from the can 120. The insulating portion 170 is positioned to surround the outer surface (lower surface) of the first current collector plate 161 and the portion of the side surface of the electrode assembly 130, thereby insulating the first current collector plate 161 and the can 120.

The insulating portion 170 may include a first insulating portion 171 (e.g., a lower surface portion) covering an outer surface (e.g., a lower surface) of the first current collector plate 161, and a second insulating portion 172 (e.g., a side surface portion) connected to an edge of the first insulating portion 171 and covering the side surface of the first current collector plate 161 and a portion of the side surface of the electrode assembly 130. The lower surface portion 171 may be referred to as the upper surface portion when the secondary battery 100 is turned upside down. The first insulating portion 171 is formed in a hexagonal shape, and an opening for passing the rivet 150 may be located in the center of the first insulating portion 171.

The second insulating portion 172 may be vertically bent from the edge of the first insulating portion 171, and is divided into a plurality of portions by a plurality of cutouts. That is, the insulating portion 170 may include a plurality of second insulating portions 172 separated by the plurality of cutouts. In the present embodiment, the plurality of cutouts includes a plurality of incision lines 173.

The insulating portion 170 may be made of a flexible (e.g., easily bendable) insulating film, and an initial form of the insulating portion may be a hexagonal flat plate with a greater width than the first insulating portion 171. For example, referring to the top of FIG. 7, the insulating portion 170 may be made by preparing a hexagonal flat insulating film 180, and processing six incision lines 173 in the insulating film 180. Then, disposing the insulating film 180 to face the first current collector plate 161, and accommodating the insulating film 180 and the electrode assembly 130 into the interior of the can 120.

As illustrated in the bottom of FIG. 7, while the insulating film 180 is accommodated into the interior of the can 120 together with the electrode assembly 130, a portion corresponding to between the plurality of incision lines 173 may be bent due to the contact with the can 120, and the plurality of second insulating portions 172 may be formed as a result of the bending.

The initial insulating film 180 may include a hexagonal central portion 181 corresponding to the first insulating portion 171 and a hexagonal ring-shaped peripheral portion 182 surrounding the central portion 181. The plurality of incision lines 173 may be located on the peripheral portion 182, and contact six edges of the peripheral portion 182. Each of the plurality of incision lines 173 may be formed in a straight line extended from six edges of the peripheral portion 182 toward a center point of the central portion 181.

The second insulating portion 172 of the insulating portion 170 may include an overlapping portion 174 with a neighboring second insulating portion 172. A first side (e.g., left side) of each second insulating portion 172 may include a triangular overlapping portion 174 bent toward the neighboring second insulating portion 172 to overlap the neighboring second insulating portion 172. A second side (e.g., right side) of each second insulating portion 172 may also include the triangular overlapping portion 174 bent toward the neighboring second insulating portion 172 to overlap the neighboring second insulating portion 172.

Therefore, the two overlapping portions 174 where neighboring two second insulating portions 172 overlap each other may be located on each of six edges of the second insulating portion 172. Two the overlapping portion 174 may be located on both sides (i.e., left and right sides) of an edge.

In the present embodiment, as the plurality of incision lines 173 are provided in the insulating portion 170, when the insulating film is accommodated in the interior of the can 120 together with the electrode assembly 130, the plurality of second insulating portions 172 may be easily bent from the first insulating portion 171 such that the side surface of the first current collector plate 161 and the portion of the side surface of the electrode assembly 130 may be stably covered, and as a result, the first current collector plate 161 and the can 120 may be securely insulated.

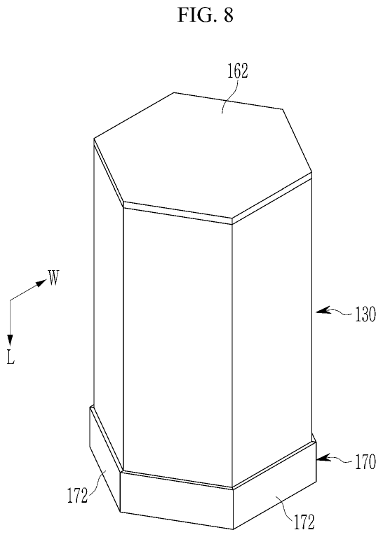

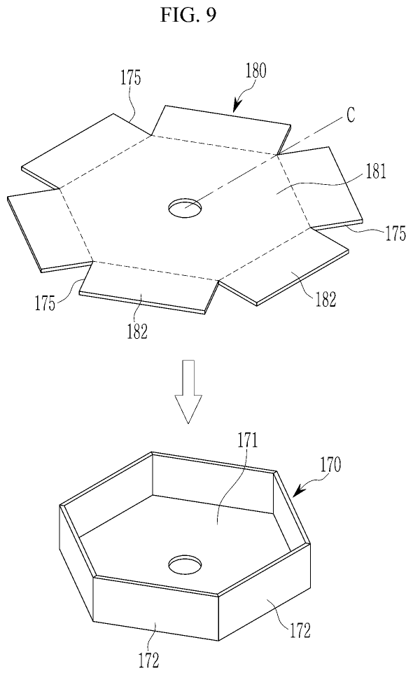

FIG. 8 is a perspective view of an electrode assembly and an insulating portion of a secondary battery according to a second embodiment. FIG. 9 is a perspective view of the insulating portion shown in FIG. 8. The secondary battery of the second embodiment has the same or similar configuration as the first embodiment described above, except for the insulating portion described below.

Referring to FIG. 2, FIG. 8, and FIG. 9, the insulating portion 170 includes the first insulating portion 171 and the plurality of second insulating portions 172 connected to an edge of the first insulating portion 171 and separated by the plurality of cutouts. In the present embodiment, the plurality of cutouts include a plurality of incision grooves 175, and each of the plurality of incision grooves 175 may be formed in a V-shape.

The initial insulating film 180 may include the hexagonal central portion 181 corresponding to the first insulating portion 171 and the six peripheral portions 182 connected to six edges of the central portion 181. Each of the peripheral portions 182 may be in a rectangular shape, and a V-shaped incision groove 175 may be located between neighboring peripheral portions 182.

Assuming an imaginary line C (refer to FIG. 9) extending from the center point of the central portion 181 to the outside through the edge of the central portion 181, the imaginary line C passes through the incision groove 175, and the incision groove 175 may form a left-right symmetry around the imaginary line C.

The plurality of peripheral portions 182 may be vertically bent from the central portion 181 to form the plurality of second insulating portions 172. The plurality of second insulating portions 172 may contact each other by side surfaces, without a portion overlapping the neighboring second insulating portion 172. That is, the plurality of second insulating portions 172 are in contact with each other through side surfaces, and may form a hexagonal ring shape. The insulating portion 170 configured as such may stably cover the lower surface and the side surface of the first current collector plate 161 and the portion of the side surface of the electrode assembly 130, and securely insulate the first current collector plate 161 and the can 120.

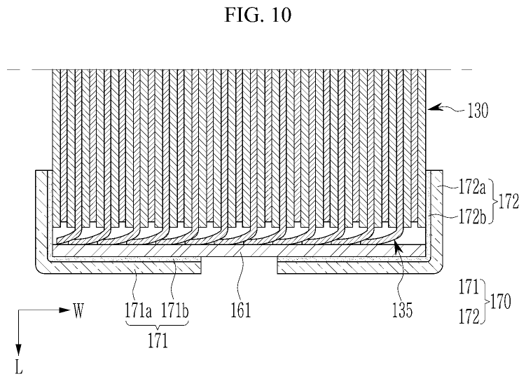

FIG. 10 is a cross-sectional view of an electrode assembly and an insulating portion of a secondary battery according to a third embodiment. The secondary battery of the third embodiment has the same or similar configuration as any of the first and second embodiments described above, except for the insulating portion described below.

Referring to FIG. 10, the insulating portion 170 may include the first insulating portion 171 and the plurality of second insulating portions 172 connected to the edge of the first insulating portion 171 and separated by the plurality of cutouts. Each of the first insulating portion 171 and the plurality of second insulating portions 172 may include insulating layers 171a and 172a, and adhesive layers 171b and 172b located on inner surfaces of the insulating layers 171a and 172a, respectively.

The insulating portion 170 may be attached to the lower surface and the side surface of the first current collector plate 161 and the portion of the side surface of the electrode assembly 130, by the adhesive layers 171b and 172b. The insulating portion 170 may be attached to the first current collector plate 161 and the electrode assembly 130 before the electrode assembly 130 is accommodated into the interior of the can 120, and the electrode assembly 130 attached with the insulating portion 170 may be accommodated into the interior of the can 120.

The insulating portion 170 configured as such may be firmly fixed to the first current collector plate 161 and the electrode assembly 130 by the adhesive layers 171b and 172b. Accordingly, position change or offset or the like of the insulating portion 170 with respect to the electrode assembly 130 may be prevented or substantially minimized, and during the assembly process of the secondary battery 100, the insulating portion 170 may be easily installed.

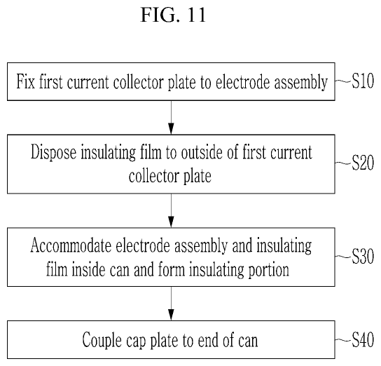

Subsequently, a manufacturing method of a secondary battery will be described with reference to FIG. 11. FIG. 11 is a process flowchart showing a manufacturing method of a secondary battery according to a fourth embodiment.

Referring to FIG. 11, a manufacturing method of a secondary battery may include a first current collector plate fixing operation S10, in which a first current collector plate is fixed to a first side of an electrode assembly, an insulating film disposing operation S20, in which an insulating film is disposed on an outer side of the first current collector plate, an electrode assembly accommodating operation S30, in which the electrode assembly and the insulating film are accommodated inside a can, and an insulating portion is formed by bending of the insulating film, and a can sealing operation S40, in which a cap plate is coupled to an end portion of the can to seal the can.

Referring to FIG. 2 and FIG. 4, in the first current collector plate fixing operation S10, the first current collector plate 161 may be fixed to the plurality of first tabs 135 located on a first side (e.g., lower side) of the electrode assembly 130 by, e.g., welding. The second current collector plate 162 may be fixed to the plurality of second tabs 136 located on a second side (e.g., upper side) of the electrode assembly 130 by, e.g., welding. Each of the plurality of first tabs 135 and the plurality of second tabs 136 is bent in one direction to have an overlapping portion with a neighboring tab, and may overlap and press each other by bending to form a substantially flat surface.

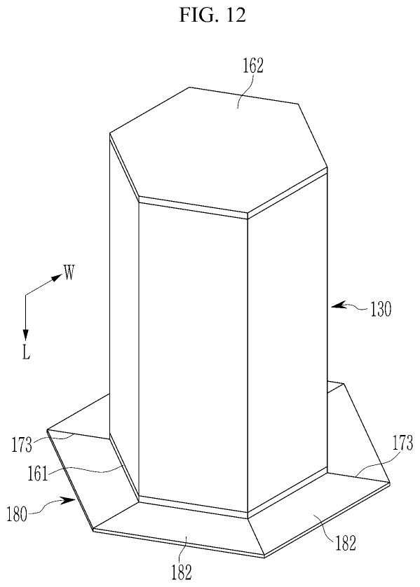

FIG. 12 is a perspective view of the electrode assembly 130 and the insulating film 180 for explaining the insulating film disposing operation S20 shown in FIG. 11.

Referring to FIG. 7 and FIG. 12, in the insulating film disposing operation S20, the hexagonal flat insulating film 180 may be disposed on an outer side of the first current collector plate 161. The insulating film 180 may be a flexible insulative film, and may include the hexagonal central portion 181 corresponding to the first insulating portion 171 and the hexagonal ring-shaped peripheral portion 182 surrounding the central portion 181. An opening for passing the rivet 150 may be located in the central portion 181, and the insulating film 180 may be located such that the central portion 181 faces the outer surface of the first current collector plate 161.

The plurality of incision lines 173 contacting the six edges may be located in the peripheral portion 182. Each of the plurality of incision lines 173 may be formed in a straight line extending from the six edges of the peripheral portion 182 toward the center point of the central portion 181. The plurality of incision lines 173 may be formed by, e.g., knife cutting or laser cutting.

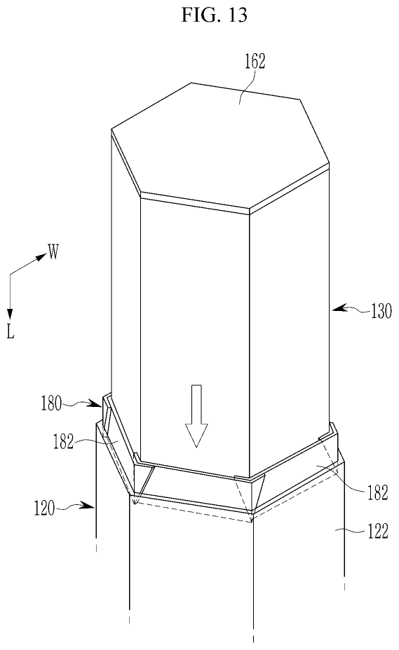

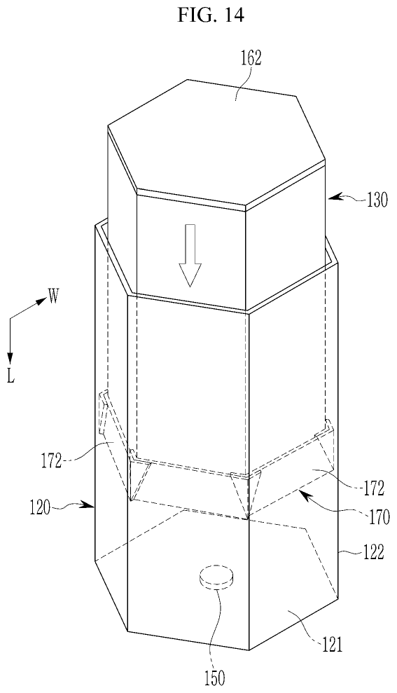

FIG. 13 and FIG. 14 are perspective views of the electrode assembly 130, the insulating portion 170, and the can 120 for explaining the electrode assembly accommodating operation S30 shown in FIG. 11.

Referring to FIG. 12 to FIG. 14, the can 120 includes the side portion 122 having the hexagonal bottom portion 121 and six surfaces, and the rivet 150 may be installed on the bottom portion 121 via an insulation gasket. In the electrode assembly accommodating operation S30, the insulating film 180 and the electrode assembly 130 enter the interior of the can 120 through the opening of the can 120, move along the length direction L, and are accommodated in the interior of the can 120.

The insulating film 180 enters the interior of the can 120 before the electrode assembly 130, so the peripheral portion 182 of the insulating film 180 contacts the end portion of the side portion 122, and may be gradually bent by movement of the electrode assembly 130 within the can 120 and then vertically bent so as to form the plurality of second insulating portions 172. Each of the plurality of second insulating portions 172 may include the triangular overlapping portion 174 overlapping the neighboring second insulating portion 172.

As such, the insulating portion 170 does not require a separate folding process. That is, by arrangement of the insulating film 180 and the movement of the electrode assembly 130, the plurality of second insulating portions 172 may be formed as the peripheral portion 182 of the insulating film 180 is smoothly bent during movement of the electrode assembly 130 within the can 120.

If the incision line 173 were not located on the insulating film 180, in the electrode assembly accommodating operation S30, shape defects, e.g., wrinkles, could be formed at the edges of the insulating film or the edge portions could overlap into multiple layers. In addition, various defects could occur, e.g., insulating film with wrinkles in certain areas may impede the entry and movement of the electrode assembly, and the insulating film being may be located outside of the designated position inside the can.

In contrast, in the present embodiment, since the peripheral portion 182 is easily bent via the plurality of incision lines 173 provided on the insulating film 180, the insulating film 180 does not impede the movement of the electrode assembly 130, and the insulating portion 170 may accurately maintain the intended shape inside the can 120 without distortion or change in position. Accordingly, the insulating portion 170 may securely insulate the first current collector plate 161 and the can 120, and the manufacturing quality of the secondary battery may be improved.

Referring to FIG. 1 and FIG. 2, in the can sealing operation S40, the cap plate 140 may be coupled to the end portion of the side portion 122 to seal the can 120. The cap plate 140 may be electrically connected to the second current collector plate 162, and the side portion 122 may contact the cap plate 140 to be charged to have the same polarity as the second electrode 132.

Alternatively, the cap plate 140 may maintain a state insulated from the second current collector plate 162 and the side portion 122 by an insulation member, and may be coupled to the end portion of the side portion 122. In this case, the second current collector plate 162 may contact the can 120, and the cap plate 140 may be electrically non-polar.

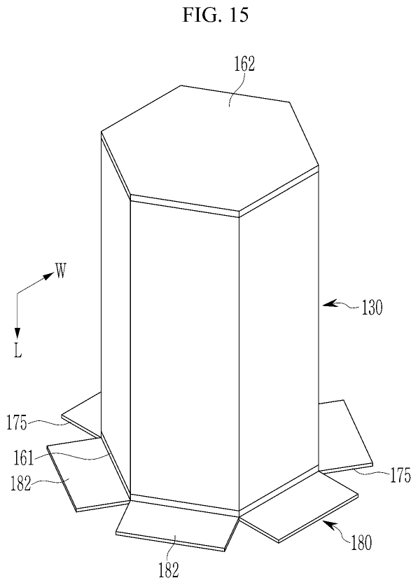

FIG. 15 is a perspective view of an electrode assembly 130 and the insulating film 180 showing the insulating film disposing operation shown in FIG. 11 according to another embodiment.

Referring to FIG. 9 and FIG. 15, the plurality of incision grooves 175 in contact with the six edges of the central portion 181 may be located in the peripheral portion 182 of the insulating film 180. Each of the plurality of incision grooves 175 may be V-shaped, and each of the plurality of peripheral portions 182 may be rectangular. Assuming an imaginary line C extending from the center point of the central portion 181 to the outside through the edge of the central portion 181, the incision groove 175 may form a left-right symmetry around the imaginary line C.

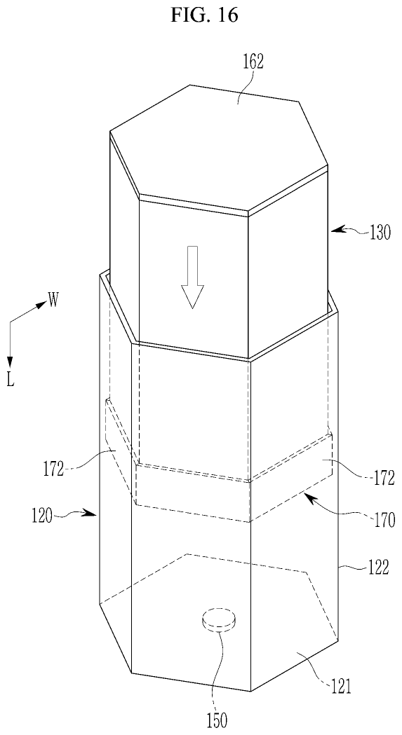

FIG. 16 is a perspective view of the electrode assembly 130, the insulating portion 170, and the can 120 showing the electrode assembly accommodating operation shown in FIG. 11 according to another embodiment.

Referring to FIG. 9 and FIG. 16, in the electrode assembly accommodating operation S30, the peripheral portion 182 of the insulating film 180 contacts the end portion of the side portion 122, and may be gradually bent by movement of the electrode assembly 130 and then vertically bent so as to form the plurality of second insulating portions 172. Each of the plurality of second insulating portions 172 may contact the neighboring second insulating portion 172 through side surfaces.

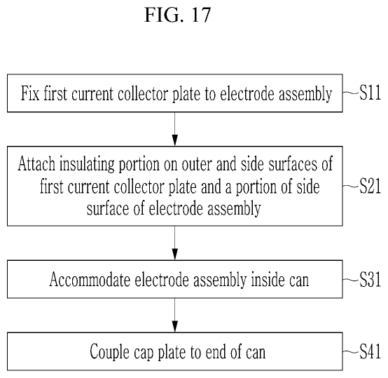

FIG. 17 is a process flowchart showing a manufacturing method of a secondary battery according to a fifth embodiment.

Referring to FIG. 17, a manufacturing method of a secondary battery may include a first current collector plate fixing operation S11, in which a first current collector plate is fixed to a first side of an electrode assembly, an insulating portion attachment operation S21, in which an insulating portion is attached to an outer surface and side surface of the first current collector plate and a portion of a side surface of the electrode assembly, an electrode assembly accommodating operation S31, in which the electrode assembly attached with the insulating portion is accommodated inside a can, and a can sealing operation S41, in which a cap plate is coupled to an opening of the can to seal the can.

Since the first current collector plate fixing operation S11 is the same as the first current collector plate fixing step S10 of the above-mentioned fourth embodiment, and the can sealing operation S41 is the same as the can sealing step S40 of the above-mentioned fourth embodiment, repetitive descriptions are not included herein.

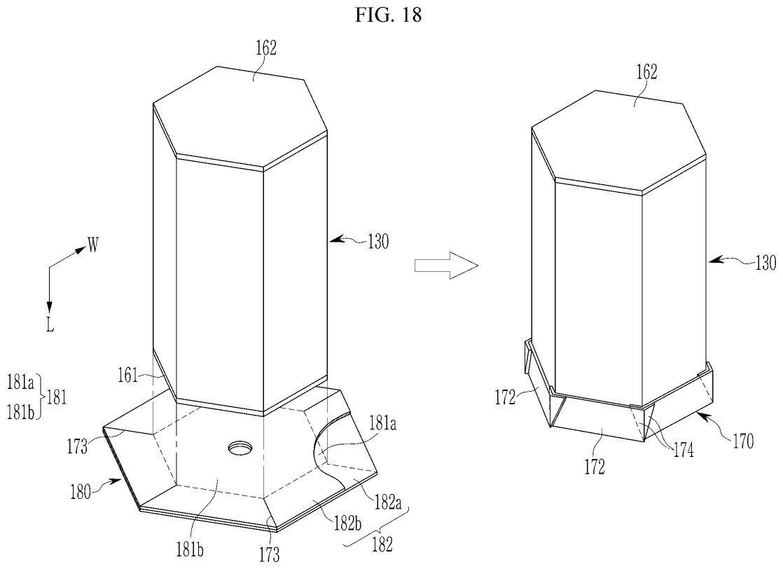

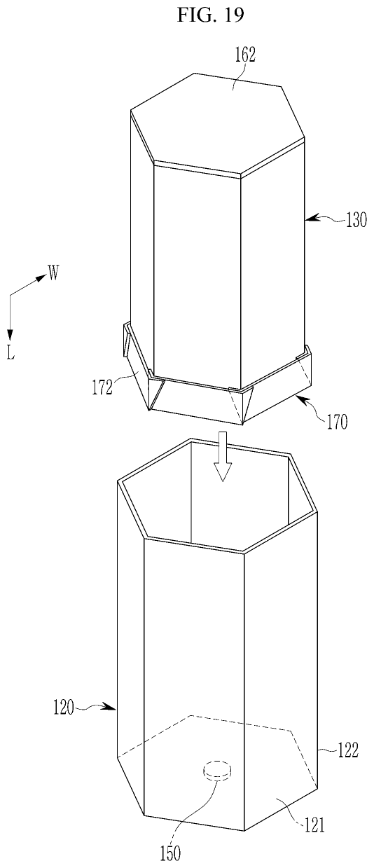

FIG. 18 is a perspective view of the electrode assembly 130 and the insulating film 180 for explaining the insulating portion attachment operation shown in FIG. 17. FIG. 19 is a perspective view of the electrode assembly, an insulating portion, and a can for explaining the electrode assembly accommodating step shown in FIG. 17.

Referring to FIG. 18, in the insulating portion attachment step S21, the insulating film 180 may include the central portion 181 and the plurality of peripheral portions 182 connected to an edge of the central portion 181 and separated by the plurality of incision lines 173. At this time, each of the central portion 181 and the plurality of peripheral portions 182 may include insulating layers 181a and 182a and adhesive layers 181b and 182b located on a first surface of the insulating layers 181a and 182a. The plurality of incision lines 173 may be replaced with the plurality of incision grooves 175 (refer to FIG. 9).

The insulating film 180 may be attached to the electrode assembly 130 such that the adhesive layer 181b of the central portion 181 may contact the outer surface of the first current collector plate 161, and the adhesive layer 182b of each of the plurality of peripheral portions 182 may contact the side surface of the first current collector plate 161 and the portion of the side surface of the electrode assembly 130. The insulating portion 170 may include the first insulating portion 171 attached to the outer surface of the first current collector plate 161 and the plurality of second insulating portions 172 attached to the side surface of the first current collector plate 161 and the portion of the side surface of the electrode assembly 130.

Each of the plurality of second insulating portions 172 may include the triangular overlapping portion 174 overlapping the neighboring second insulating portion 172. Alternatively, when the plurality of incision lines 173 is replaced with the plurality of incision grooves 175, each of the plurality of second insulating portions 172 may be in contact with the neighboring second insulating portion 172 by side surfaces (refer to FIG. 9).

Referring to FIG. 19, in the electrode assembly accommodating operation S31, the electrode assembly 130 attached with the insulating portion 170 enters the opening of the can 120 and then moves along the length direction L to be accommodated inside the can 120. Since the insulating portion 170 is already attached to the electrode assembly 130 before the electrode assembly 130 is accommodated inside the can 120, the electrode assembly 130 may be smoothly accommodated into the can 120 without any obstruction.

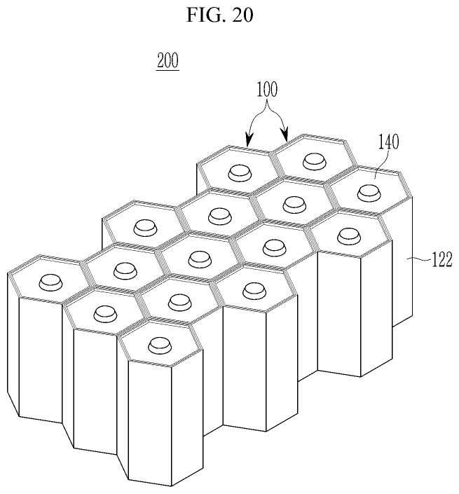

FIG. 20 is a schematic diagram of a battery module according to an embodiment.

Referring to FIG. 20, a battery module 200 may include a plurality of secondary batteries 100 disposed to contact each other through the side portion 122 of the can 120, e.g., adjacent ones of the plurality of secondary batteries 100 may directly contact each other along entire facing surfaces of corresponding side portions 122 of adjacent cans 120. The plurality of secondary batteries 100 may be secondary batteries of the above-mentioned first through third embodiments. Due to the hexagonal pillar-shaped cans 120, the plurality of secondary batteries 100 may be located closely adjacent to (e.g., directly contacting) each other via the side portions 122 of the cans 120 without an empty space (e.g., dead space) therebetween.

In a battery module composed of a plurality of cylindrical secondary batteries, empty spaces occur between neighboring secondary batteries. In contrast, in the battery module 200 of the present embodiment, such empty spaces do not occur between neighboring secondary batteries 100. Thus, according to the battery module 200 of the present embodiment, spatial efficiency is increased and provides advantage in increasing the output and capacity of the battery module.

By way of summation and review, the present disclosure provides a secondary battery and a manufacturing method thereof, capable of increasing output and capacity of the battery module by increasing integration of secondary batteries when composing a battery module by combining a plurality of secondary batteries. That is, according to an embodiment, since the electrode assembly may be disposed inside a hexagonal pillar-shaped can and minimizing an empty space, output and capacity of the battery may be increased. In addition, since an insulating portion may be positioned to surround an outer surface of a first current collector plate and a portion of a side surface of the electrode assembly, electrical insulation between the first current collector plate and the can may be ensured.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a can including a hexagonal bottom portion and a side portion having six surfaces;
a hexagonal pillar-shaped electrode assembly accommodated inside the can;
a first current collector plate coupled to a first side of the hexagonal pillar-shaped electrode assembly, the first current collector plate facing the hexagonal bottom portion;
an insulating portion surrounding an outer surface of the first current collector plate and a portion of a side surface of the hexagonal pillar-shaped electrode assembly, the insulating portion insulating the first current collector plate from the can, and the insulating portion including:
a first insulating portion covering the outer surface of the first current collector plate, and
a plurality of second insulating portions separated by a plurality of cutouts, the plurality of second insulating portions surrounding the portion of the side surface of the hexagonal pillar-shaped electrode assembly; and
a cap plate coupled to an end portion of the side portion of the can and sealing the can.

2. The secondary battery of claim 1, wherein:
the hexagonal pillar-shaped electrode assembly includes a plurality of electrodes having different widths and stacked along a width direction of the secondary battery, and
each of the plurality of electrodes has a quadrangular sheet shape.

3. The secondary battery of claim 2, wherein:
a long side of each of the plurality of electrodes is parallel to a length direction of the secondary battery, and
a short side of each of the plurality of electrodes is parallel to any two surfaces facing each other among the six surfaces of the side portion of the can.

4. The secondary battery of claim 1, wherein:
the hexagonal pillar-shaped electrode assembly includes a plurality of first tabs on the first side facing the hexagonal bottom portion, and
the plurality of first tabs is bent along one direction and coupled to the first current collector plate.

5. The secondary battery of claim 1, wherein:
the plurality of cutouts includes a plurality of incision lines, and
each of the plurality of second insulating portions includes an overlapping portion with a neighboring one of the plurality of second insulating portions.

6. The secondary battery of claim 1, wherein:
the plurality of cutouts includes a plurality of incision grooves, and
each of the plurality of second insulating portions is in contact with a neighboring one of the plurality of second insulating portions via corresponding side surfaces.

7. The secondary battery of claim 1, wherein:
each of the first insulating portion and the plurality of second insulating portions includes an insulating layer, and an adhesive layer on an inner surface of the insulating layer, and
the insulating portion is attached to the outer surface of the first current collector plate and the portion of the side surface of the hexagonal pillar-shaped electrode assembly via the adhesive layer.

8. A manufacturing method of a secondary battery, the manufacturing method comprising:
fixing a first current collector plate to a first side of a hexagonal pillar-shaped electrode assembly;
disposing a hexagonal insulating film on an outer surface of the first current collector plate, the hexagonal insulating film having a plurality of cutouts;
entering the hexagonal insulating film and the hexagonal pillar-shaped electrode assembly into an opening of a can and moving into the can, such that the hexagonal insulating film bends due to contact with the can when entering the opening of the can to form an insulating portion that includes a first insulating portion covering the outer surface of the first current collector plate and a plurality of second insulating portions covering a portion of a side surface of the hexagonal pillar-shaped electrode assembly; and
sealing the can by coupling a cap plate to an end portion of the can.

9. The manufacturing method of claim 8, wherein:
the hexagonal insulating film includes a hexagonal central portion facing the outer surface of the first current collector plate, and a peripheral portion surrounding the hexagonal central portion, and
the plurality of cutouts is in the peripheral portion, the plurality of cutouts separating the peripheral portion into a plurality of portions.

10. The manufacturing method of claim 9, wherein the plurality of cutouts includes a plurality of incision lines extended from six edges of the peripheral portion toward a center point of the hexagonal central portion.

11. The manufacturing method of claim 10, wherein:
the hexagonal insulating film contacts the end portion of the can, and the plurality of second insulating portions are formed as a plurality of peripheral portions that are vertically bent from the hexagonal central portion by movement of the hexagonal pillar-shaped electrode assembly, and
each of the plurality of second insulating portions has an overlapping portion with a neighboring one of the plurality of second insulating portions.

12. The manufacturing method of claim 9, wherein the plurality of cutouts includes a plurality of V-shaped incision grooves in contact with six edges of the hexagonal central portion.

13. The manufacturing method of claim 12, wherein:
the hexagonal insulating film contacts the end portion of the can, and the plurality of second insulating portions are formed as a plurality of peripheral portions that are vertically bent from the hexagonal central portion by movement of the hexagonal pillar-shaped electrode assembly, and
each of the plurality of second insulating portions is in contact with a neighboring one of the plurality of second insulating portions via side surfaces.

14. A manufacturing method of a secondary battery, the manufacturing method comprising:
fixing a first current collector plate to a first side of a hexagonal pillar-shaped electrode assembly;
attaching an insulating portion, formed in a dual layer structure of an adhesive layer and an insulating layer, to an outer surface of the first current collector plate and to a portion of a side surface of the hexagonal pillar-shaped electrode assembly;
accommodating the hexagonal pillar-shaped electrode assembly attached with the insulating portion inside a can; and
sealing the can by coupling a cap plate to an end portion of the can.

15. The manufacturing method of claim 14, wherein attaching the insulating portion includes:
preparing an insulating film including a hexagonal central portion facing the outer surface of the first current collector plate and a peripheral portion surrounding the hexagonal central portion, and separating the peripheral portion into a plurality of portions by a plurality of cutouts; and
attaching the hexagonal central portion to the outer surface of the first current collector plate, and attaching the plurality of peripheral portions to a portion of the side surface of the hexagonal pillar-shaped electrode assembly by vertically bending the plurality of peripheral portions from the hexagonal central portion.

16. The manufacturing method of claim 15, wherein the plurality of cutouts includes:
a plurality of incision lines extended from six edges of the peripheral portion toward a center point of the hexagonal central portion, or
a plurality of V-shaped incision grooves in contact with six edges of the hexagonal central portion.
